(19) United States
(12) Patent Application Publication
(10) Pub. No.: US 2013/0218356 A1
(43) Pub. Date: Aug. 22, 2013

(54) ENERGY CONTROL METHOD FOR ENERGY MANAGEMENT SYSTEM

(71) Applicant: Electronics and Telecommunications Research Institute, (US)

(72) Inventors: Jeong In LEE, Daejeon (KR); Il Woo LEE, Daejeon (KR)

(73) Assignee: Electronics and Telecommunications Research Institute, Daejeon (KR)

(21) Appl. No.: 13/761,894

(22) Filed: Feb. 7, 2013

(30) Foreign Application Priority Data
Feb. 17, 2012 (KR) 10-2012-0016193

(51) Int. Cl. G06Q 50/06

(52) U.S. Cl. CPC G06Q 50/06
USPC 700/291

(57) ABSTRACT

An energy control method for an energy management system provides an operation plan for the energy management system for monitoring and controlling an energy charging and discharging state according to an energy storage type, since energy self-sufficiency at home is enabled through association between an energy storage system (ESS) such as an electric vehicle charging station and home as a renewable energy power supply in the form of a distributed energy resource (DER) is constructed at home. The energy control method adds functions of a home energy management system (HEMS) managing and controlling a renewable energy power supply, the ESS, and the electric vehicle charging station that may be constructed at home afterwards, thereby providing consumers with a control order of various facilities not considered before. Therefore, information on settlements caused by energy supply and demand procedures and energy trading details and management evaluation functions may be provided.

### CROSS-REFERENCE TO RELATED APPLICATION

This application claims the benefit of Korean Patent Application No. 10-2012-0016193, filed on Feb. 17, 2012, in the Korean Intellectual Property Office, the disclosure of which is incorporated herein by reference.

### BACKGROUND

1. Field of the Invention

The present invention relates to an energy control method for an energy management system that provides an operation plan for the energy management system for monitoring and controlling an energy charging and discharging state according to an energy storage type, since energy self-sufficiency at home is enabled through association between an energy storage system (ESS) such as an electric vehicle charging station and home as a renewable energy power supply in the form of a distributed energy resource (DER) is constructed at home.

2. Description of the Related Art

A conventional energy saving technology has been developed and commercialized in the form of an energy-saving mode in an individual home appliance. Currently, a technology has been developed and commercialized in which smart appliances that receive electricity prices, that is, demand response (DR) information, and accordingly operate in a power saving mode at a high-price time zone and operate in a normal mode at a low-price time zone.

However, according to such a passive-type energy saving technology, it is difficult to cope with a sudden increase in demand since real time reflection of the price information is almost infeasible. Also, the energy saving effect may not be satisfactory. Therefore, if functions of the smart appliances, including an on and off function, are controlled directly by a smart terminal according to an active energy control technology under user permission, real time response to a peak demand may be maximized. Accordingly, rolling blackout or large-scale blackout that happened last time due to a sudden increase in demand may be prevented while achieving energy saving.

A smart grid denotes a power system to optimize energy efficiency through digitalization of a grid. Lately, according to situation of the times, the smart grid is drawing attention worldwide and progressed as policies in various countries.

A DR refers to a method of inducing the consumer to reduce energy consumption or providing an incentive when a wholesale power price is high or reliability of the system is low. The DR is being spotlighted as a most significant application field for spread of the smart grid technology.

A plurality of home appliance companies throughout the world, for example GE and Whirlpool of U.S.A. and LG of South Korea, are also developing and commercializing smart appliances equipped with functions related to the smart grid.

According to a conventional DR related technology, energy price information is notified through the web, thereby inducing the consumer to directly operate home appliance at a relatively inexpensive time zone. Alternatively, a display of the smart appliance may be equipped with a driving time reservation function along with the energy price information per time zone, so that the smart appliance is operated at the relatively inexpensive time zone.

In relation to the DR, direct load control of the smart appliance may be enabled by energy utility and the like. However, according to the market research related to the smart appliances, most consumers are afraid that their private information such as information on their own home appliances may be exposed to the outside due to the direct load control, and therefore want final control of the appliances to be performed by themselves.

With introduction of the smart grid, efforts are being made for efficient energy use at home and reduction in carbon emission, based on the infrastructure combining the grid and the information communication technology.

A smartmeter is under development, which is for measuring data related to energy demand management by remotely collecting home energy information based on an advanced metering infrastructure (AMI). According to development of an intelligent home appliance internally equipped with a power measurement and communication function, researches are performed for a home energy management system (HEMS) to monitor and control home energy consumption using the function.

Most of the foregoing technologies are related to technological functions including display, control, management, and verification of energy related data such as home electricity and gas. The foregoing technologies do not verify a procedure of confirming an access trouble through association with the HEMS.

As supply of renewable energy to home and real time energy trading are accomplished with introduction of the smart grid, an energy storage system (ESS) is being developed to solve imbalance between demand and supply of energy. That is, the ESS is being spread in the form of a transmission system associated type, an energy source associated type, and a customer associated type in home. In addition, according to spread of electric vehicles, the electric vehicle charging station is going to be constructed at public facilities, highway service areas, and home including an apartment complex and a detached house, and the like. Although technologies regarding the storage system and the charging station are under development, functions of a home energy management system (HEMS) to collectively manage and control energy supply are absent.

Currently, a HEMS capable of two-way communication based on an advanced metering infrastructure (AMI) and a smartmeter has been developed, having a function of monitoring of real time energy use information.

### SUMMARY

An aspect of the present invention provides an energy control method for an energy management system capable of managing a charging and discharging state of energy supplied by a renewable energy, separately by an electric vehicle charging station and an energy storage system (ESS) according to a user selection, and also capable of providing an energy trading settlement function when receiving shortage energy lacking in the storage system and the charging station in association with an existing grid and when selling surplus energy.

According to an aspect of the present invention, there is provided an energy control method of an energy management system, including determining availability of energy generation by a renewable energy based on data measured by an environmental sensor, obtaining real time rates provided by an electricity company when energy generation by the renewable energy is available, performing comparison with previous real time rates stored in the energy management system and analysis of the obtained real time rates, selecting whether to supply the renewable energy according to the analyzed real time rates, storing energy in an energy storage system (ESS) and an electric vehicle charging station when the real time rates are lower than electricity rates, and receiving supply of energy from a grid when energy supply using the renewable energy is less than energy demanded by home.

### EFFECT

According to embodiments of the present invention, an information and operation evaluation function are provided with respect to settlement details that may be caused by various procedures regarding energy supply and demand and accompanying energy trading, by adding a function of a home energy management system (HEMS) capable of managing and controlling a renewable energy power supply, an energy storage system (ESS), and an electric vehicle charging station which may be constructed at home afterward, and thereby providing consumers with a control order and method of various facilities that have not been considered before.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an operational flow of an energy control method for a home energy management system (HEMS) associated with an electric vehicle charging station and an energy storage system (ESS), according to an embodiment of the present invention;

FIG. 2 is a diagram illustrating an operational flow of a control sub routine of an ESS, according to an embodiment of the present invention; and

FIG. 3 is a diagram illustrating an operational flow of a control sub routine of an electric vehicle charging station, according to an embodiment of the present invention.

### DETAILED DESCRIPTION

According to an embodiment of the present invention, real time rates measurement provided by an electric power company may be achieved through construction of renewable energy facilities and storage system, two-way communication, and advanced metering infrastructure. Therefore, a consumer may store energy generated by a renewable energy power supply in a home storage system in case of a light load, or use the energy in case of a peak load, by participating in demand response (DR). Thus, energy use efficiency may be optimized. The consumer may construct an energy storage system (ESS) and an electric vehicle charging station, may store or supply energy to any one of the ESS and the electric vehicle charging station as desired by selecting a storage mode of a home energy management system (HEMS), and may sell surplus energy through inverse power transmission to the electric power company in association with a grid or receive shortage of energy from the grid. Accordingly, the embodiment of the present invention introduces a control function for a HEMS further capable of management and control of the ESS, rates settlement, and the like.

Reference will now be made in detail to exemplary embodiments of the present invention, examples of which are illustrated in the accompanying drawings, wherein like reference numerals refer to the like elements throughout.

Hereinafter, an energy control method for an energy management system according to an embodiment of the present invention will be descried with reference to the drawings.

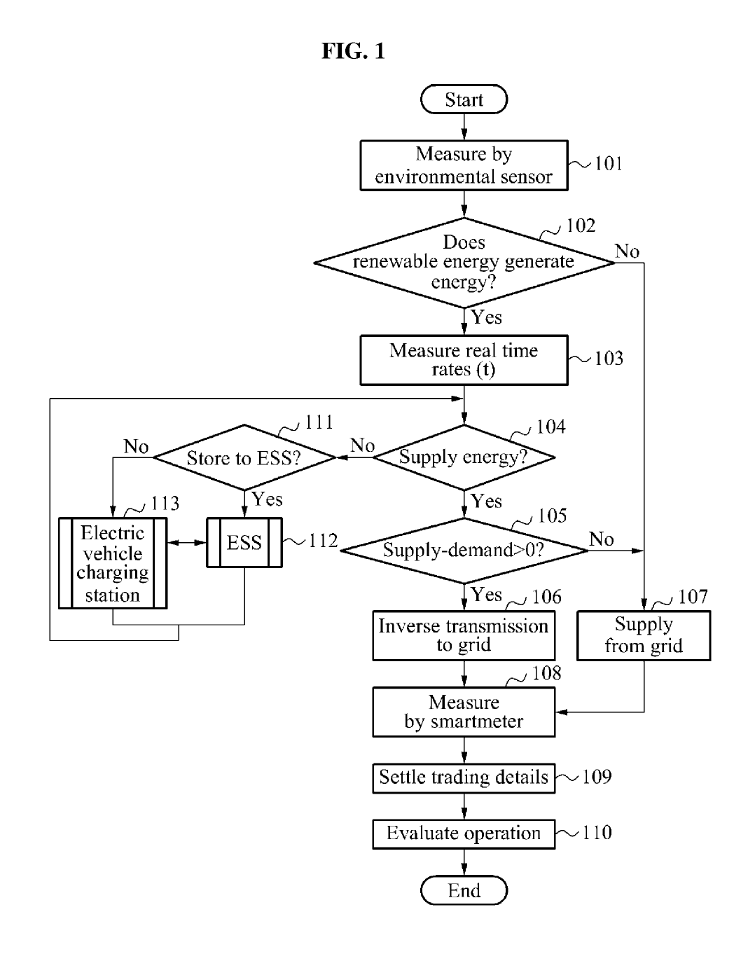

FIG. 1 is a diagram illustrating an operational flow of an energy control method for a home energy management system (HEMS) associated with an electric vehicle charging station and an ESS, according to an embodiment of the present invention.

The present embodiment provides a management and control function through a HEMS to an ESS and electric vehicle charging station facilities added to home according to association with a renewable energy.

FIG. 1 illustrates a flowchart of control and management of a HEMS associated with a renewable energy power supply, an ESS 112, and an electric vehicle charging station.

The energy management system may measure amount of energy generated by a renewable energy through data measurement using an environmental sensor sensing weather, temperature, humidity, and the like according to an association type of the renewable energy in operation 101, and determine availability of renewable energy generation based on the data measured by the environmental sensor in operation 102.

When the renewable energy generation is available, the energy management system may obtain real time rates information provided by an electric power company in operation 103 to supply the generated renewable energy to a home load device. The energy management system may compare and analyze the real time rates information with respect to previous real time rates stored in the energy management system in operation 104, and select whether to supply the energy based on the analysis result in operation 105.

When the real time rates are lower than the previous rates, time of use (TOU) rates, or peak rates or when it is not a peak load, the energy management system may store the energy instead of supplying the energy to home so that the energy may be used when the real time rates are high or when it is the peak load. Here, an energy storage method may be divided into the ESS 112 in home and an electric vehicle charging station 113. The energy storage method may be selected by the consumer in operation 112.

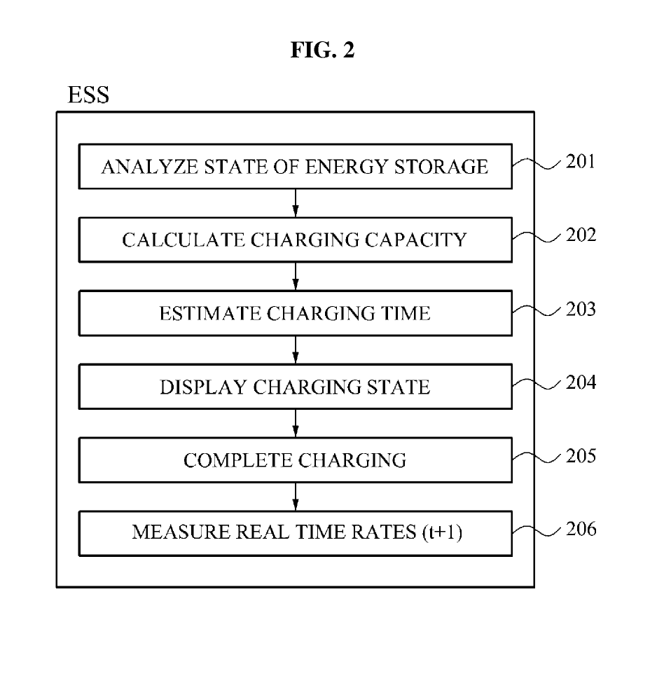

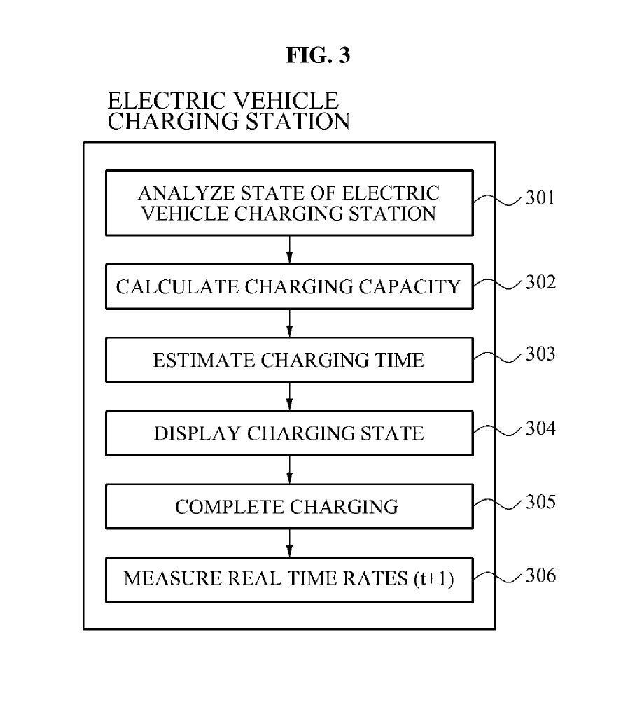

The energy management system may store and supply energy by measuring time after real time rates (t) according to a control order of a control sub routine type shown in FIGS. 2 and 3. A storage space is varied according to the selected storage method. The stored energy may be supplied to an electric car and a home load system. Shortage of energy may be supplied through association with the grid in operation 108 by comparing supply and demand in operation 106.

The energy management system may measure quantity of energy supply by a smartmeter in operation 109, and settle accounts with respect to energy trading according to balance of energy supply and demand, the energy trading including basic electricity rates, energy use rates, an incentive according to use of renewable energy, and an electricity rates discount of when the grid is used, in operation 110. Also, the energy management system may perform operation evaluation by analyzing details of the energy use in operation 111.

When the real time rates are high or when it is the peak load, the energy management system may supply the renewable energy to home. When energy supply using the renewable energy is less than energy demand, the energy management system is supplied with the energy from the grid. When surplus energy is generated due to energy generation of the renewable energy, the energy may be sold by inverse transmission to the grid in operation 107.

When the surplus energy is inversely transmitted to the existing grid, the energy management system may measure the electricity by the smartmeter and thereby provide functions related to account settlements with respect to the energy trading and operational evaluation.

The foregoing describes the procedure of energy supply and demand of when a renewable energy power supply may generate energy according to the weather. Hereinafter, a control flowchart of the HEMS will be described with respect to a case in which a renewable energy power supply may not generate energy by environmental factors such as weather and climate.

When energy is not generated by the renewable energy power supply, necessary energy is supplied in association with the grid with respect to the demand of a home load system. In addition, functions are provided related to account settlements with respect to the energy trading through measurement of power by a smartmeter and operational evaluation.

FIG. 2 is a diagram illustrating an operational flow of a control sub routine of an ESS, according to an embodiment of the present invention.

Referring to FIG. 2, the ESS shows a sub routine operational flow related to energy storage and energy supply. The ESS may store the energy when the real time energy rates t are low. The energy management system needs to analyze a state of the ESS in operation 201, and calculate a charging capacity of the ESS proportional to generated energy in operation 202. In addition, the ESS needs to estimate charging time in operation 203, display a charging state when charging begins in operation 204, and complete charging in operation 205. The energy management system may measure real time rates t+1 of after a time t for use of the energy after charging in operation 206, and may select whether to supply the energy by comparison with previous data and analysis. The energy management system may repeat the energy supply and demand procedure described above.

FIG. 3 is a diagram illustrating an operational flow of a control sub routine of an electric vehicle charging station, according to an embodiment of the present invention.

Referring to FIG. 3, a sub routine operational flow is shown related to energy storage and energy supply of the electric vehicle charging station. When the real time rates t are low, the electric vehicle charging station may store energy. The energy management system needs to analyze a state of the electric vehicle charging station in operation 301, and calculate a charging capacity of the electric vehicle charging station proportional to generated renewable energy in operation 302. In addition, the energy management system needs to estimate charging time in operation 303, display a charging state when charging begins in operation 304, and complete charging in operation 305. The energy management system may measure the real time rates t+1 for use of the energy after charging in operation 306, and may supply energy of the electric vehicle charging station to an electric vehicle when it is a peak load or when the real time rates are high as a result of comparison with previous data and analysis.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An energy control method of an energy management system, the energy control method comprising:
determining availability of energy generation by a renewable energy based on data measured by an environmental sensor;
obtaining real time rates provided by an electricity company when energy generation by the renewable energy is available;
performing comparison with previous real time rates stored in the energy management system and analysis of the obtained real time rates;
selecting whether to supply the renewable energy according to the analyzed real time rates;
storing energy in an energy storage system (ESS) and an electric vehicle charging station when the real time rates are lower than electricity rates; and
receiving supply of energy from a grid when energy supply using the renewable energy is less than energy demanded by home.

2. The energy control method of claim 1, further comprising:
selling surplus energy generated by the renewable energy through inverse transmission to the grid.

3. The energy control method of claim 2, further comprising:
analyzing a state of the ESS when the real time rates are low;
estimating a charging time by calculating a charging capacity of the ESS and performing charging; and
measuring the real time rates and supplying the energy of the ESS to a home load when it is a peak load or when the real time rates are high.

4. The energy control method of claim 1, further comprising:
supplying energy to a home load in association with the grid when the renewable energy does not generate energy.

5. The energy control method of claim 2, further comprising:
analyzing a state of the electric vehicle charging station when the real time rates are low;
estimating a charging time by calculating a charging capacity of the electric vehicle charging station and performing charging; and
measuring the real time rates and supplying the energy of the electric vehicle charging station to an electric vehicle when it is a peak load or when the real time rates are high.

6. The energy control method of claim 1, further comprising:
supplying energy stored in the electric vehicle charging station to an electric vehicle when the renewable energy does not generate energy.
